(19) United States
(12) Patent Application Publication
(10) Pub. No.: US 2007/0035282 A1
(43) Pub. Date: Feb. 15, 2007

(54) Switch mode power supply and a method for controlling such a power supply

(76) Inventor: Lars Petersen, Virum (DK)

Correspondence Address: Donald S Dowden;Cooper & Dunham, 1185 Avenue of the Americas, New York, NY, 10036, US

(21) Appl. No.: 10/546,067

(22) PCT Filed: Aug. 26, 2003
(86) PCT No.: PCT/DK03/00557

§ 371 Date: Oct. 13, 2006

(30) Foreign Application Priority Data
Feb. 21, 2003 (DK) PA 2003 00266
May 8, 2003 (US) 469,364

(51) Int. Cl. G05F 1/00

(52) U.S. Cl. 323/282

(57) ABSTRACT

The present invention relates to a switch mode power supply comprising an input, an output and an intermediate circuit between the input and the output. The intermediate circuit is provided with a voltage source. A current source is provided between the positive and negative pole of the output, said current source being power-coupled to the voltage source. In this way, the apparent ratio between the input voltage and the output voltage is altered, and the operation of the switch mode converter circuit is enabled and improved. The present invention relates also to a method of controlling such a power supply.

### TECHNICAL FIELD

The present invention relates to a switch mode power supply comprising an input, an output and an intermediate circuit.

A typical power supply often consists of three parts: a voltage source, a converter unit and a load, where the converter unit converts energy from the voltage source in such a way that said energy can be received by the load in a suitable manner. The source can be an AC or a DC voltage source, and, in case of the nominal value of the voltage source varying within a not inconsiderable range, it may be appropriate to provide the converter unit as two separate units each with its own function. The first unit must compensate for the variations from the voltage source and convert this voltage to a fixed DC voltage, said DC voltage being predominantly independent of the voltage supplied by said voltage source. The second unit must then convert the energy from a constant, well-defined voltage source, i.e. the voltage from said first converter unit, to a voltage adapted to the current requirements of the load, such as a constant DC voltage or a voltage varying with time. The reason for the desire to split the conversion into two operations is that it is often desirable to provide the load with power from a converter with galvanic isolation. An often used and well-known converter type employed to provide such galvanic isolation is a so-called buck-derived converter type, i.e. a converter type based on the well-known buck converter circuit, but modified with galvanic isolation. A buck converter operates best with only small variations of the voltage source, for which reason the converter function has been split into two parts, as mentioned above. Although the converter unit as a whole consists of two units, it has on the whole a better overall efficiency, as each individual unit converts energy in the way it is best suited for.

In the case that the voltage source provides AC voltage, e.g. from the mains, the first converter unit has typically two principle tasks. Apart from handling voltage variations from the voltage source, said unit must also ensure that the power is taken from the mains according to applicable standards. This is due to the fact that converter units often have an interfering effect on the mains, because they frequently draw power from the mains in a discontinuous way, such as in the form of diode currents from a diode bridge rectifier. Converter units trying to take power from the mains according to the above-mentioned standards are often called PFC (Power Factor Correction) converters or power factor correction circuits. Thus, power factor correction circuits are able to spread the power uptake over a wider time frame, thereby resulting in a power uptake better corresponding to an ohmic load, where current and voltage each are approximately sinusoidal and the phase displacement between current and voltage is minimal. In the present context power uptake of an ohmic load represents the ideal power uptake of a power supply, since such an uptake has the least interfering effect on the mains.

The most common way to design a power factor correction converter is by means of a so-called boost converter. A boost converter is superior to other types of converters, such as a buck converter, a buck/boost converter and the like, since said converter can as a rule easily fulfill applicable standards for power uptake of voltage sources, since it has a superior efficiency, and the power is received in a continuous fashion with predominantly sinusoidal currents and voltages and little phase displacement, thus reducing the impact of the converter unit on the mains and thereby also reducing the need for filters.

However, the boost converter in itself has several drawbacks. It is, for example, difficult to incorporate a current limiter function, and one of the requirements for a converter of said type is that the output voltage is always higher than the input voltage, otherwise the converter is unable to control the voltage. If for some reason the input voltage of the boost converter is higher than the output voltage, there are no means provided to limit the current. The inability to limit current in a boost converter causes several problems when starting the converter. Likewise, problems may also arise, if subsequent units are defective, e.g. short-circuited.

Several of the above-mentioned problems can be avoided by using a so-called buck/boost converter. A converter of this type can limit the current, and the output voltage of the converter can, in principle, be freely selected, i.e. the output voltage can be both increased and decreased. This additional degree of freedom can be used to optimize the subsequent unit. The most important disadvantage of a converter of this type is, however, its poor efficiency. Poor efficiency is due to the fact that the individual components of the converter are exposed to a greater “stress”, which means i.a. that any conducted current is high, resulting in an increased loss at the individual components. A “great” loss at a component often means that larger and often more expensive components must be used and/or that the converter unit must be provided with a better/larger cooling system to carry away heat losses.

### BACKGROUND ART

The converter types mentioned above, such as boost converters, buck converters, buck/boost converters and the like, are well-known to a person skilled in the art. Although converters of this type have only become widely used within the last years (10 or maybe 20 years), the circuits themselves are well-known, for example from “Power Electronics Converters, Applications, and Design”, Mohan, Undeland, Robbins, ISBN 0-471-58408-8.

Moreover, U.S. Pat. No. 6,373,725 discloses a converter unit using two different converter types, a flyback converter and a SEPIC converter, respectively. The converter is provided with means to switch between the two converter types depending on the input voltage. However, this converter unit is not suitable, as it is not one converter capable of handling a plurality of voltages, but in reality two converters connected in parallel where either one or the other is used.

### DISCLOSURE OF INVENTION

Switch mode power supplies according to the present invention are characterized in that a voltage source is provided in the intermediate circuit between the input and the output, that a current source is provided between the positive and the negative pole of the output, and that the voltage of the voltage source depends on the voltage of the current source. Thus—seen from the input of the switch mode power supply—the output voltage is connected in series to the voltage source, the apparent ratio—seen from the input—between the input voltage and the output voltage thereby becoming the ratio between the input voltage and the output voltage plus voltage of the voltage source. Thus and although the output voltage is lower than the input voltage, a boost converter can for example be used, profiting from the above-mentioned advantages without the operation of said boost converter being made impossible, and at the same time a better efficiency of the circuit can be obtained, since the ratio between the input voltage and the apparent output voltage is changed.

In a second preferred embodiment according to the present invention a galvanic isolation is provided between the input and the output of the switch mode power supply. Thus the output voltage of the switch mode power supply can have a floating potential compared to the input voltage of the switch mode power supply.

In a third preferred embodiment according to the present invention the inserted voltage source and the galvanic isolation comprise a single unit. Thus, the load current is partly divided between several components which is advantageous from a thermal point of view, and partly the transistor being part of the boost converter can optionally be omitted.

Preferred embodiments of the voltage source and the current source are described in the dependent claims, methods of controlling the electronic breaker components of the voltage source are also described.

### BRIEF DESCRIPTION OF THE DRAWINGS

The invention is explained in detail below with reference to the drawing(s), in which

FIG. 1 shows a known DC power supply with a transformer and a diode rectifier,

FIG. 2 shows a known boost converter circuit to be used in a power supply,

FIG. 3 shows a switch mode power supply according to the present invention with the boost converter circuit of FIG. 2, but modified with a voltage source and a current source,

FIG. 4-11 show preferred embodiments of the switch mode power supply according to the present invention with the modified boost converter of FIG. 3,

FIG. 12 shows the switch mode power supply according to the present invention with the boost converter of FIG. 2 as illustrated in FIG. 3, but modified with a voltage source and a current source, where in contrast to FIG. 3 the current source is positioned directly after the voltage source.

FIGS. 13 and 14 show embodiments of the modified boost converter of FIG. 12,

FIG. 15 shows a safety circuit for the embodiment of FIG. 4,

FIG. 16 shows a switch mode power supply according to FIG. 3 with built-in galvanic isolation,

FIGS. 17 and 18 show preferred embodiments of the switch mode power supply according to FIG. 16,

FIG. 19 shows preferred embodiments of the switch mode power supply according to FIG. 3 with built-in galvanic isolation, where the two voltage sources are combined into one unit,

FIG. 20 illustrates the switch positions of the electronic breaker components based on the embodiment of FIG. 4,

FIG. 21 illustrates the switch positions of the electronic breaker components based on the embodiment of FIG. 14,

FIG. 22 shows the turning on and off of the electronic breaker components based on the embodiment of FIG. 19

FIG. 23 shows a known buck converter circuit to be used in a power supply,

FIGS. 24 and 25 show a buck converter modified according to the invention, and

FIG. 26 shows the turning on and off of the electronic breaker components based on the embodiment of FIGS. 24 and 25.

In the following detailed description the same references identify identical components or units.

### BEST MODES FOR CARRYING OUT THE INVENTION

Electronic breaker components are depicted with a simple switch symbol. This is partly because a contact breaker function used in a switch mode power supply, e.g. a boost converter, and often in the form of a transistor, is aimed to resemble an ideal switch function and partly because different types of usable electronic breaker components have different symbols. It is further assumed that means, e.g. in the form of a micro-computer, are provided to control switching the electronic breaker component on and off, and that means in the form of driver circuits are provided to switch the electronic breaker component on and off. As a rule, means for measuring currents and voltages are also provided. The above-mentioned means are well-known to a person skilled in the art. These means are not illustrated in the drawing for the sake of clarity.

In the following detailed description, the switch mode power supply according to the present invention is described on the basis of a boost converter, but other known converter circuits, such as buck or buck/boost and the like, can also be used to design a switch mode power supply according to the principles of the present invention.

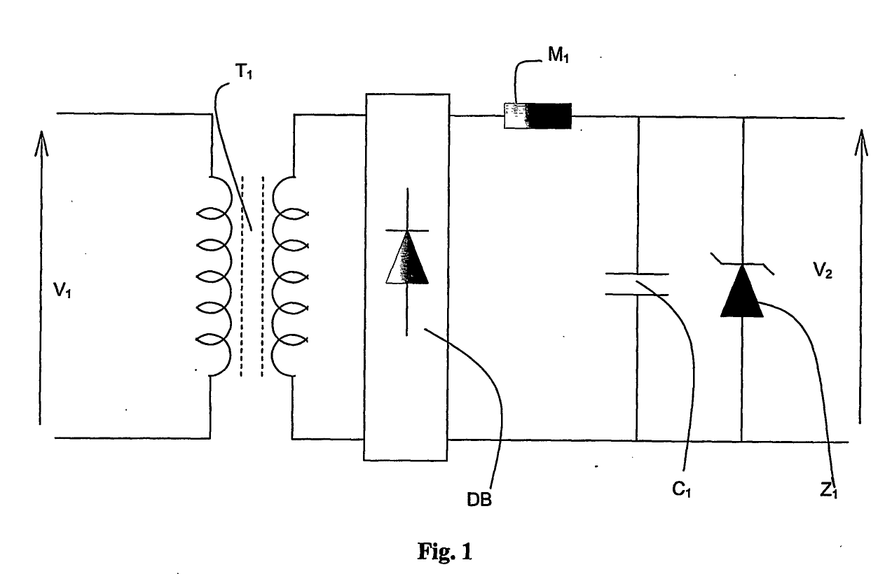

FIG. 1 shows a known DC power supply where an input voltage V₁ is transformed to an operating voltage by means of a transformer T₁, said operating voltage being subsequently rectified by means of a diode bridge DB and smoothed out by means of a capacitor C₁ to an output voltage V₂.

A resistor M₁ is provided between diode bridge DB and capacitor C₁. Said normally small resistor M₁ contributes to the commutation of the diodes in the diode bridge, thereby lowering the diodes' current loads. A Zener diode Z₁ is arranged between the output terminals and limits the maximum output voltage. Zener diode Z₁ may, however, be omitted. Resistor M₁ may also be omitted, however, this will result in a higher load on the diode bridge. The diode bridge DB employed can be one of several types, such as a coupling with one or four diodes. DC power supplies of said type are inexpensive and robust, but lack flexibility, since the output voltage is load-dependent and the circuit has very limited capabilities for taking alterations in the input voltage into account. Transformer T1 may be provided with a tap either on the primary winding or the secondary winding, so that for example the European voltage 230 V/50 Hz or the North American voltage 115 V/60 Hz can be taken into account.

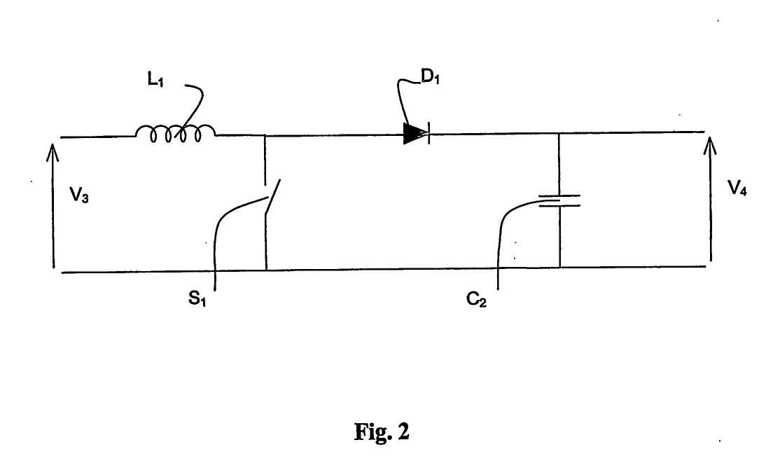

FIG. 2 shows a schematic diagram of a boost converter capable of converting one input DC voltage to another, higher output DC voltage. A boost converter includes an inductor L₁ connected in series to one side of an electronic breaker component S₁, said connection in series L₁, S₁ being provided between the positive and negative pole of an input voltage V₃. The anode of a diode D₁ is connected to the connection point between inductor L₁ and electronic breaker component S₁. The cathode of diode D₁ is connected to the positive pole of output voltage V₄ and one side of a capacitor C₁. The negative pole of input voltage V₃ is connected to the negative pole of output voltage V₄, the other side of electronic breaker component S₁ and the other side of capacitor C₁. For this purpose electronic breaker components as the one designated S₁ are employed. In the schematic diagram the electronic breaker component S₁ is depicted as a switch, where the “on”-state has a very small resistance—typically less than 1 Ohm—between the power terminals, i.e. the terminals on the electronic breaker component carrying the load current, or the “off”-state has a high resistance—typically more than 100 kOhm—between the power terminals. A boost converter operates in such a way that a current flows from the input terminals of said converter through inductor L₁ and electronic breaker component S₁, thereby charging inductor L₁ with energy, when electronic breaker component S₁ is switched on. Upon subsequently switching off the electronic breaker component, said energy is discharged through diode D₁ to capacitor C₂. Because of the rate of change for the current in inductor L₁ a voltage is generated and added to the input voltage. By varying the ratio between the time periods, when electronic breaker component S₁ is switched on and when it is switched off, the resulting voltage across capacitor C₁ is higher than input voltage V₃. The voltage across capacitor C₂ corresponds to output voltage V₄. The size of inductor L₁ and capacitor C₂ depends on the energy to be stored during those periods, when electronic breaker component S₁ is switched on or off. By increasing the frequency for switching the electronic breaker component S₁ on and off, the required size of inductor L₁ and capacitor C₂ can be reduced resulting in a considerable decrease of the physical size of the boost converter circuit. The frequency for switching electronic breaker component S₁ on and off can be very low, but is often comparatively high and in the range of 20-100 kHz or higher. The illustrated boost circuit works satisfactorily, but has certain drawbacks. For example, if input voltage V₃ is higher than the desired output voltage V₄, the operation of the circuit is interfered with and it is no longer possible to control the output voltage. Another drawback is that if the ratio for increasing input voltage V₃ to obtain the desired output voltage V₄ is high, the efficiency of the circuit is considerably reduced. Therefore, a boost circuit is often not sufficient, if a desired circuit must be capable of increasing or decreasing a DC voltage in order to take local voltage variations into account.

There are other types of converters such as buck converters capable of decreasing a DC voltage, a boost buck/boost converter capable of increasing and decreasing a DC voltage and other types. Each of these converter types has its advantages and disadvantages with regard to their capability of increasing and/or decreasing the voltage, and their efficiency depends on the ratio for changing the input voltage in order to obtain the output voltage. These disadvantages can be taken into account by combining converter types and changing between the various converters depending on the needs of the moment.

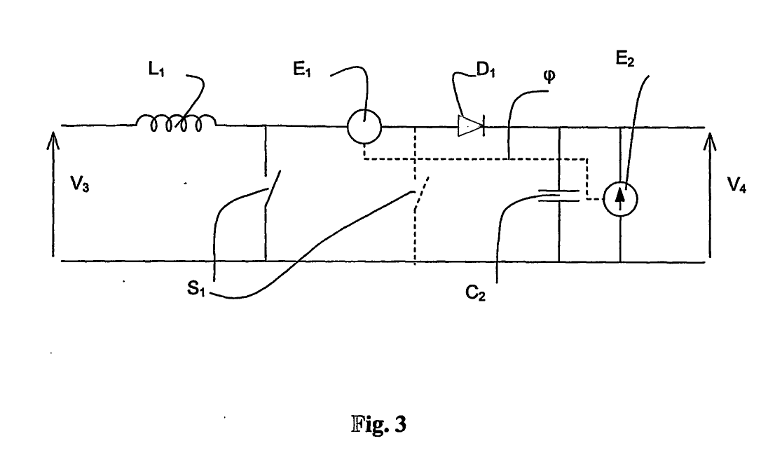

FIG. 3 shows a modified boost converter circuit differing from the converter circuit of FIG. 2 by having a voltage source E₁ provided between inductor L₁ and diode D₁, and having a current source E₂ provided between the positive and negative pole of output V₄. Current source E₂ is power-coupled, for example inductively, to voltage source E₁. Due to the function of current source E₂ and its coupling to voltage source E₁ output voltage V₄ appears as the voltage of voltage source E₁ scaled with a certain ratio. The operation of current source E₂ and voltage source E₁ is described below. Since the voltage of the controlled voltage source—as seen from the input terminals of the modified boost converter—is to be added to output voltage V₄, the apparent ratio between input voltage V₃ and output voltage V₄ is altered in such a way that the boost converter is effective, although output voltage V₄ is lower than input voltage V₃. The power coupling between voltage source E₁ and current source E₂ is illustrated symbolically by means of the dotted line φ between said sources. It should be noted that an alternative position of electronic breaker component S₁ is indicated by a dotted line. The alternative position allows the circuit shown to function as a buck boost converter with two electronic breaker components. This is possible because, as described in greater detail below, the voltage source may have a switch function corresponding to the one of the other electronic contact components.

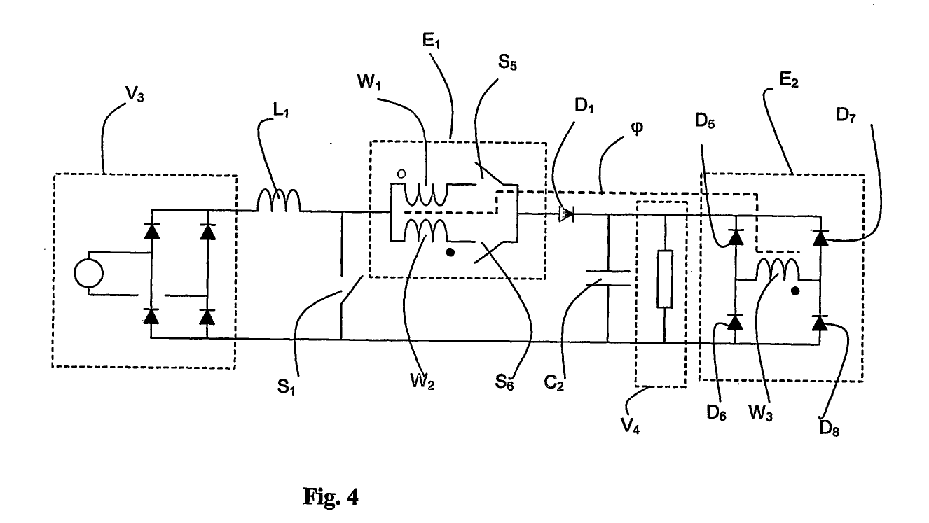

FIG. 4 shows the modified boost converter of FIG. 3 with voltage source E₁ and current source E₂ in greater detail. As is apparent, voltage source E₁ comprises a first and second winding W₁, W₂, where one end of each winding is connected in series to electronic breaker components S₅, S₆. The connection in series of winding W₁ and electronic breaker component S₅ is connected in parallel to the connection in series of winding W₂ and electronic breaker component S₆. The two windings W₁ and W₂ are connected in such a way that they have opposite polarity, as illustrated by opposite dot notation. Current source E₂ comprises two diodes D₅ and D₆, where the anode of diode D₅ is connected to the cathode of diode D₆, and where the cathode of diode D₅ is connected to the positive pole of output V₄, and the anode of diode D₆ is connected to the negative pole of output V₄. Two more diodes D₇ and D₈ are also connected in series such that the anode of diode D₇ is connected to the cathode of diode D₈, and the cathode of diode D₇ is connected to the cathode of diode D₅, and the anode of diode D₈ is connected to the anode of diode D₆. A winding W₃ is provided between the connection point between diodes D₅ and D₆ and the connection point between diodes D₇ and D₈. The three windings W₁, W₂ and W₃ are wound around the same core and coupled to the same main flux, the latter being symbolized by means of a dotted lined designated φ. Output voltage V₄ is scaled using a suitable control of electronic breaker components S₅ and S₆ with a certain ratio in relation to the ratio between windings W₁, W₂ and W₃, and added to output voltage V₁₄ as voltage source E₁. The energy taken up by voltage source E₁ is coupled to current source E₂, said current source thereby transferring the energy to output V₄.

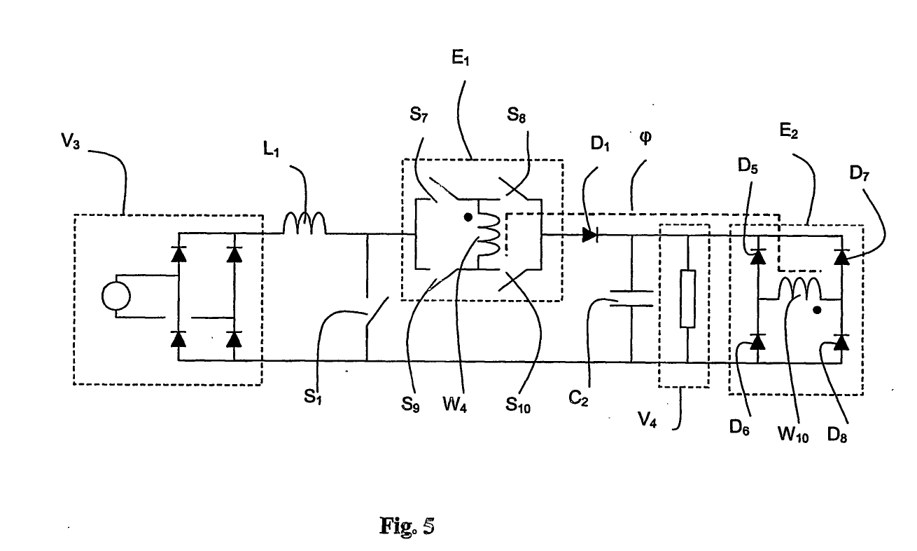

FIG. 5 shows another preferred embodiment of the modified boost converter. Current source E₂ is identical to the one of FIG. 4, while the controlled voltage source has been changed compared to FIG. 4. The controlled voltage source E₁ comprises two electronic breaker components S₇ and S₈ connected in series and two more electronic breaker components S₉ and S₁₀ also connected in series. The connection in series of the two electronic breaker components S₇ and S₉ is connected in parallel to the connection in series of the two electronic breaker components S₉ and S₁₀. A winding W₄ is provided between the connection point between the two electronic breaker components S₇ and S₈ and the connection point between the two electronic breaker components S₉ and S₁₀. Winding W₄ is inductively coupled to winding W₃ of current source E₂. The voltage induced in winding W₄ is added to output voltage V₄ using a suitable control for electronic breaker components S₇, S₈, S₉ and S₁₀. The energy taken up by voltage source E₁ is coupled to current source E₂, said current source thereby transferring the energy to output V₄.

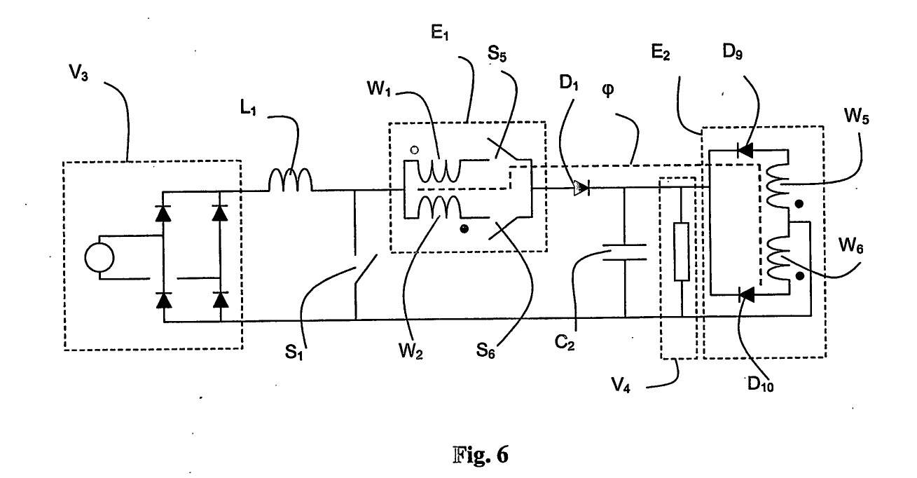

FIG. 6 shows yet another embodiment of the modified boost converter. The controlled voltage source E₁ corresponds to the controlled voltage source of FIG. 4. Current source E₂ comprises a diode D₁₀ its anode being connected to one end of a winding W₅, and a second diode D₉ its anode being connected to one end of a winding W₆. The cathodes of the two diodes D₉ and D₁₀ are interconnected as well as connected to the positive pole of output voltage V₄. The ends of the two windings W₅ and W₆ not connected to the anodes of diodes D₉ and D₁₀ are interconnected and connected to the negative pole of output voltage V₄. The two windings W₅ and W₆ have opposite polarity, as depicted by the dot notation, and are inductively coupled to windings W₁ and W₂ of the controlled voltage source E₁.

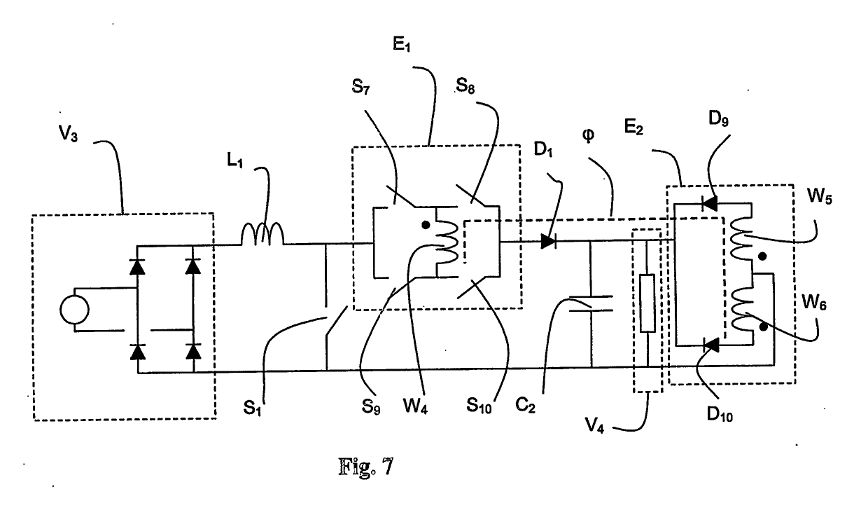

FIG. 7 shows a further embodiment of a modified boost converter. The controlled voltage source E₁ of FIG. 7 corresponds to the controlled voltage source E₁ of FIG. 5, and current source E₂ corresponds to current source E₂ of FIG. 6. The windings of the controlled voltage source E₁ and current source E₂ are also inductively coupled.

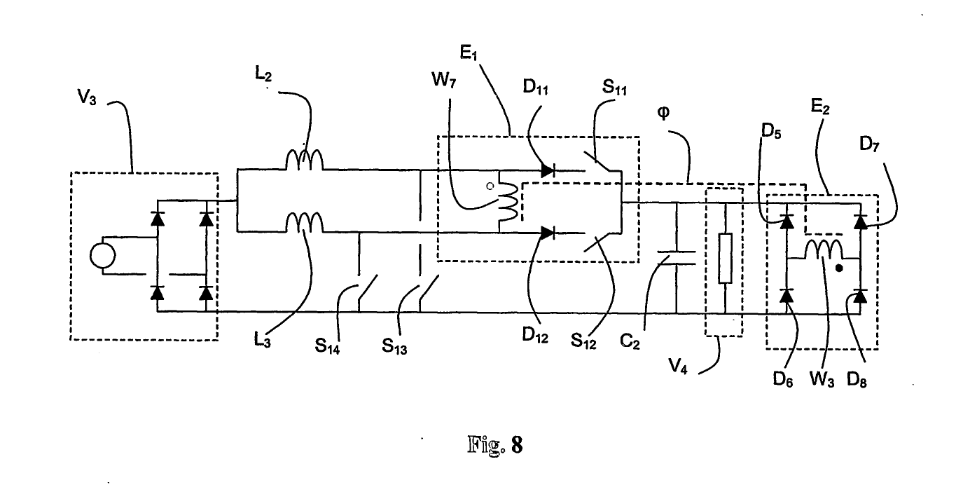

FIG. 8 shows a further embodiment of the present invention. Current source E₂ corresponds to current sources E₂ of FIGS. 4 and 5. The controlled voltage source E₁ comprises a first diode D₁₁ its cathode being connected in series to one side of an electronic breaker component S₁₁. Moreover, the controlled voltage source E₁ comprises a second diode D₁₂ its cathode being connected in series to one side of an electronic breaker component S₁₂. The other sides of the two electronic breaker components S₁₁, S₁₂ are interconnected. A first winding W₇ is connected between the anode of first diode D₁₁ and the anode of second diode D₁₂. The voltage of the controlled voltage source E₁ is induced between the other sides of electronic breaker components S₁₁, S₁₂ and either the anode of first diode D₁₁ or the anode of second diode D₁₂. The other sides of electronic breaker components S₁₁, S₁₂ are connected to the positive pole of output V₄. The anode of first diode D₁₁ is connected to one side of an inductor L₂ and one side of an electronic breaker component S₁₃, respectively. The anode of second diode D₁₂ is connected to one side of a second inductor L₃ and one side of an electronic breaker component S₁₄, respectively. The other sides of the two electronic breaker components S₁₃, S₁₄ are interconnected and connected to the negative pole of input V₃ and the negative pole of output V₄, respectively. The other sides of the two inductors L₂, L₃ are interconnected and connected to the positive pole of input V₃. The windings of voltage source E₁ are inductively coupled to windings W₃, W₅, W₆ of current source E₂.

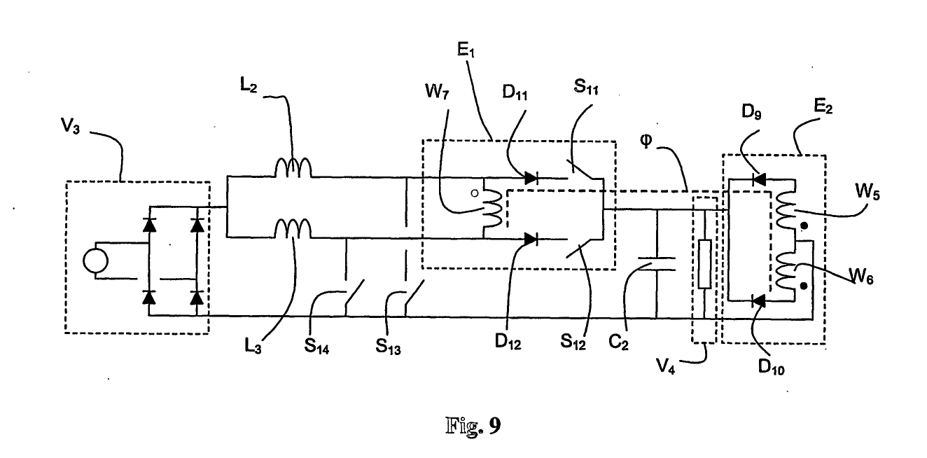

FIG. 9 shows a further embodiment of the present invention. Current source E₂ corresponds to the current sources of FIGS. 6 and 7. The controlled voltage source E₁ corresponds to the controlled voltage source of FIG. 8.

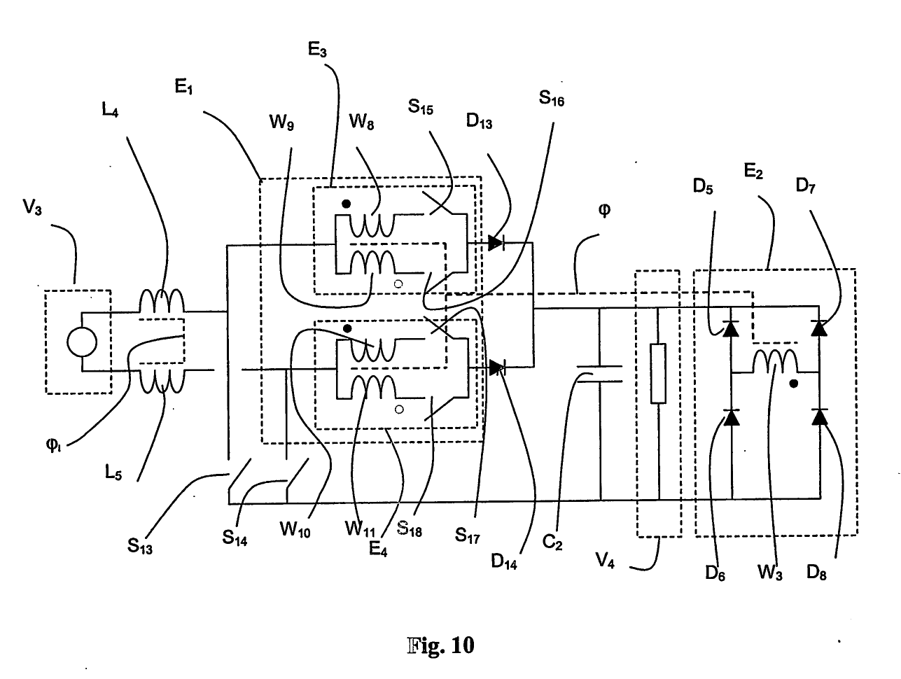

FIG. 10 shows a further embodiment of the present invention. In contrast to the embodiments illustrated in FIGS. 4-9 the input voltage is a pure AC voltage and not a rectified AC voltage. Current source E₂ corresponds to the current sources of FIGS. 4, 5 and 8. In this embodiment, the controlled voltage source E₁ comprises a first and a second voltage sub-source E₃ and E₄. Voltage sub-source E₃ comprises a first winding W₈ connected in series to an electronic breaker component S₁₅ and a winding W₉ connected in series to an electronic breaker component S₁₆. The two connections in series are connected in parallel, the dot notation of said two windings W₈ and W₉ being opposite. This parallel connection represents voltage sub-source E₃. Voltage sub-source E₄ corresponds to voltage sub-source E₃, however W₈, W₉, S₁₅, S₁₆ are replaced by W₁₀, W₁₁, S₁₇ and S₁₈. The two voltage sub-sources E₃ and E₄ are connected in series to the anode of diode D₁₃ and the anode of diode D₁₄, respectively. The cathodes of diodes D₁₃ and D₁₄ are interconnected. The other end of voltage sub-source E₃ is connected to one terminal of an inductor L₄ and an electronic breaker component S₁₃. The second voltage sub-source E₄ is connected to the input of an inductor L₅ and an electronic breaker component S₁₄. The other ends of the two inductors L₄ and L₅ are connected to voltage source V₃. The other sides of the two electronic breaker components S₁₃ and S₁₄ are interconnected and connected to the negative pole of the output. As indicated by means of φ₁, the two inductors L₄ and L₅ are located on the same core. This is not a prerequisite, however, if it is the case, said inductors also act as a filter for common-mode noise.

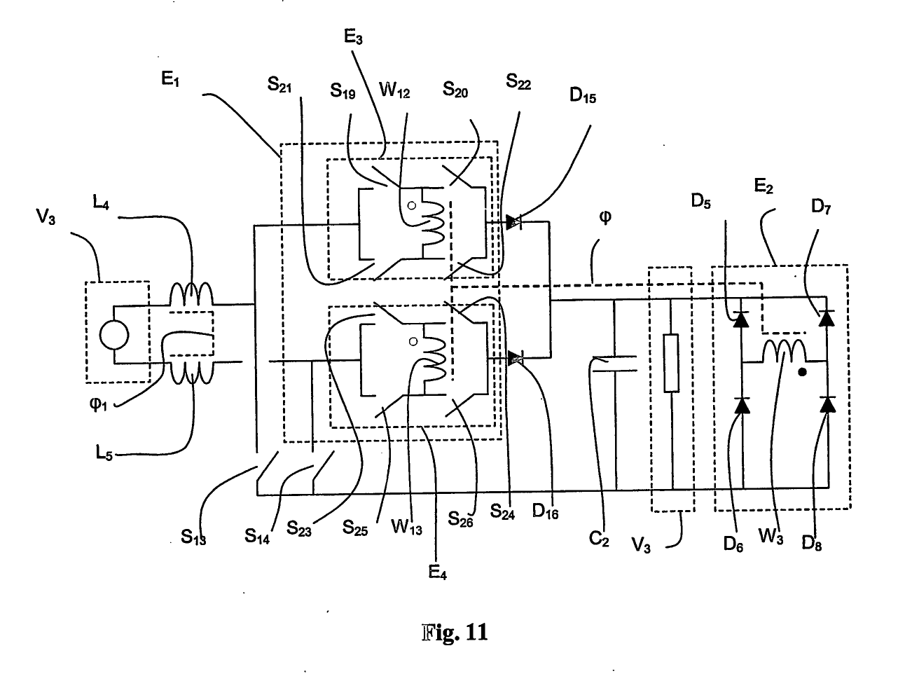

FIG. 11 corresponds to the embodiment of FIG. 10, with the difference that the first voltage sub-source E₃ comprises a first electronic breaker component S₁₉ connected in series to an electronic breaker component S₂₀ and an electronic breaker component S₂₁ connected in series to an electronic breaker component S₂₂. The two connections in series of the electronic breaker components are connected in parallel, and a winding W₁₂ is connected between the connection point between electronic breaker component S₁₉ and electronic breaker component S₂₀ and the connection point between electronic breaker component S₂₁ and electronic breaker component S₂₂. The second voltage sub-source E₄ corresponds to the first voltage sub-source E₃ with the difference that electronic breaker components S₁₉, S₂₀, S₂₁ and S₂₂ are replaced by electronic breaker components S₂₃, S₂₄, S₂₅, S₂₆ and that winding W₁₂ is replaced by winding W₁₃.

It is apparent that the current sources of FIGS. 10 and 11 can also correspond to the current sources of FIG. 6, FIG. 7 and FIG. 9.

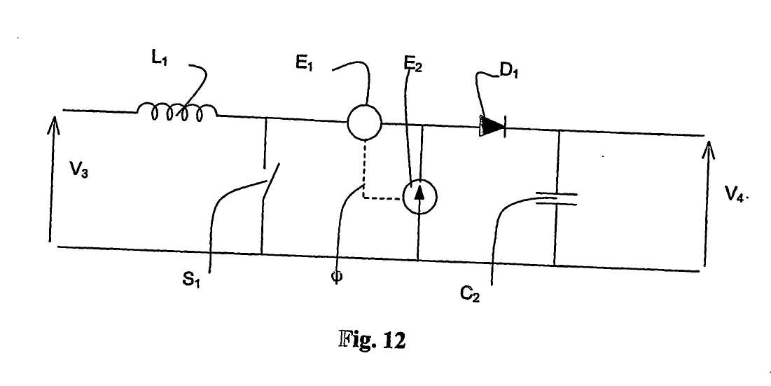

FIG. 12 shows a modified boost circuit as shown in FIG. 3, where in contrast to the circuit of FIG. 3 current source E₂ is located between voltage source E₁ and diode D₁. Electrically speaking this has no impact on how the circuit operates, but allows for new possibilities with respect to designing voltage source E₁ and current source E₂.

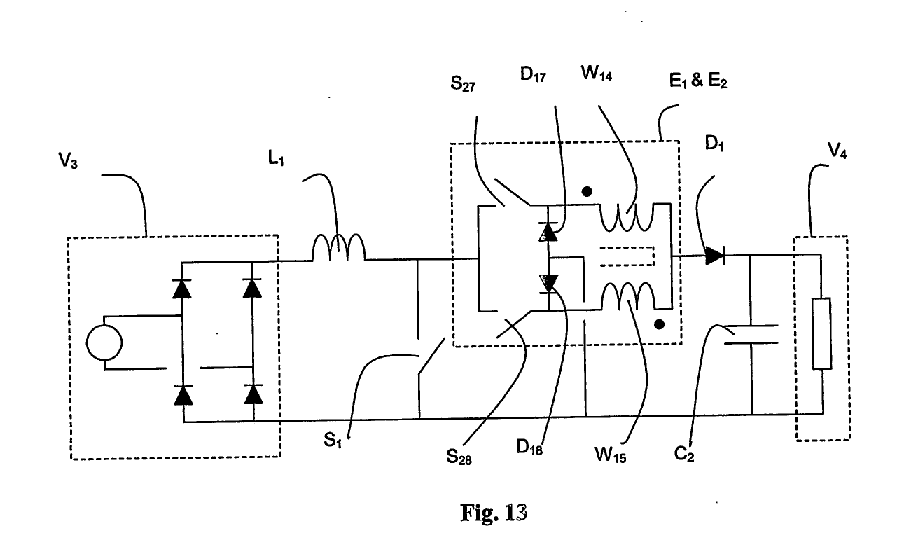

FIG. 13 shows a power supply according to the present invention, where voltage source E₁ and current source E₂ are designed based on the circuit illustrated in FIG. 12. In this embodiment of the power supply voltage source E₁ and current source E₂ are combined in the same unit. The unit comprises a first electronic breaker component S₂₇ connected in series to a winding W₁₄ and an electronic breaker component S₂₈ connected in series to a winding W₁₅. The other ends of the two windings W₁₄ and W₁₅ are interconnected, and the other ends of the two electronic breaker components S₂₇ and S₂₈ are also interconnected. The cathode of a diode D₁₇ is connected to the connection point between electronic breaker component S₂₇ and winding W₁₄, and the cathode of a diode D₁₈ is connected to the connection point between electronic breaker component S₂₈ and winding W₁₅. The anodes of the two diodes D₁₇ and D₁₈ are interconnected and connected to the negative pole of output V₄. When electronic breaker component S₂₇ is switched on and the electronic breaker component S₂₈ is switched off, winding W₁₄ comprises voltage source E₁ and diode D₁₈ and winding W₁₅ comprise the current source. When electronic breaker component S₂₈ is switched on and electronic breaker component S₂₇ is switched off, winding W₁₅ comprises voltage source E₁ and diode D₁₇ and winding W₁₄ comprise current source E₂. The coupling between windings W₁₄ and W₁₅ corresponds to a large extend to an autotransformer with a fixed conversion ratio of 1:1.

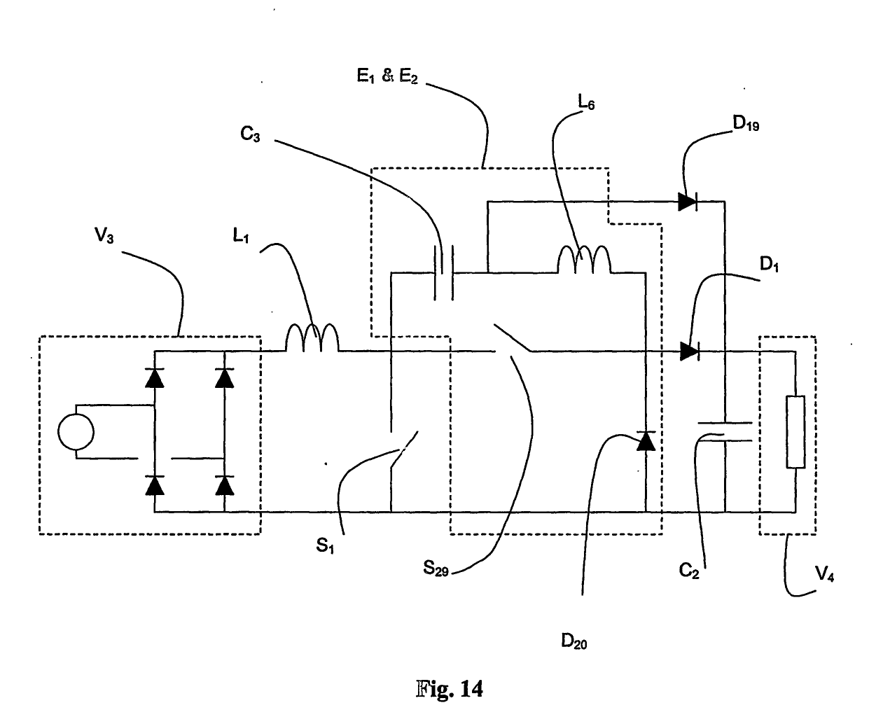

FIG. 14 shows a power supply according to the present invention and designed on the basis of the general principle shown in FIG. 12 in the same way as the embodiment of FIG. 13. Voltage source E₁ and current source E₂ are again combined. Voltage source E₁ is predominantly comprised of capacitor C₃ connected in series and via diode D₁₉ to output voltage V₄. Current source E₂ is predominantly comprised of inductor L₆. The power coupling between voltage source E₁ and current source E₂ is induced by means of electronic breaker component S₂₉ so that the power taken up by voltage source E₁ is transferred to current source E₂ when the contact component is closed.

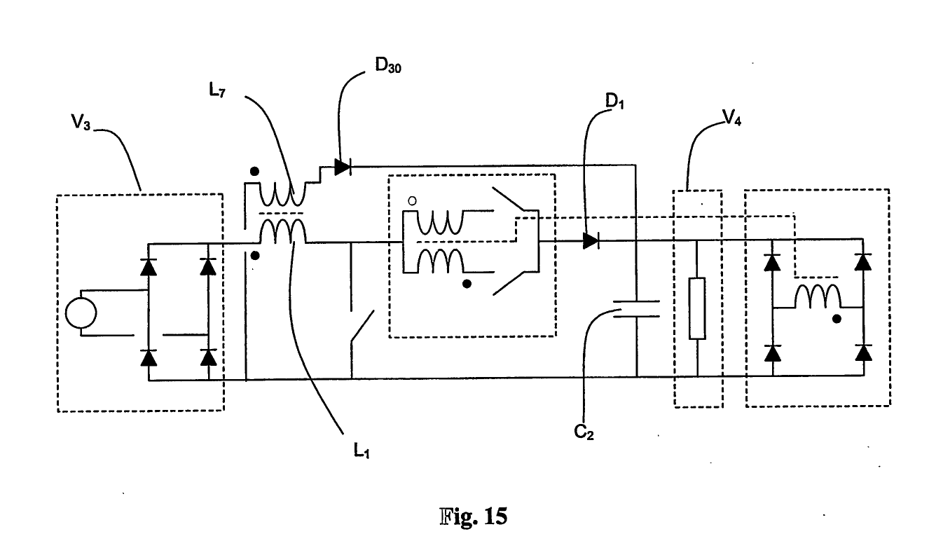

If the electronic breaker components of voltage source E₁ are switched off simultaneously, i.e. if they correspond to open contact breakers, as illustrated in FIGS. 5-11 and 13, the current through inductor L₁ can cause overvoltages, possibly resulting in damage to the switch mode power supply. This can be avoided, if a safety circuit is added, as illustrated in FIG. 15. Said safety circuit is shown based on the circuit of FIG. 4, but it is apparent that it can be altered to correspond to the other embodiments. Here, an inductor L₆ is wound around the same core as inductor L₁ and has the same dot notation as the latter. One side of the new inductor L₇ is connected to the negative pole of output V₄. The other side of inductor L₇ is connected to the anode of a diode D₃₀, and the cathode of diode D₃₀ is connected to the positive pole of output V₄. This provides a path for the current to flow through inductor L₁, if electronic breaker components S₅ and S₆ are switched off. It is obvious that the other embodiments illustrated in FIGS. 6-11 and 13 require a larger or corresponding number of windings/diodes.

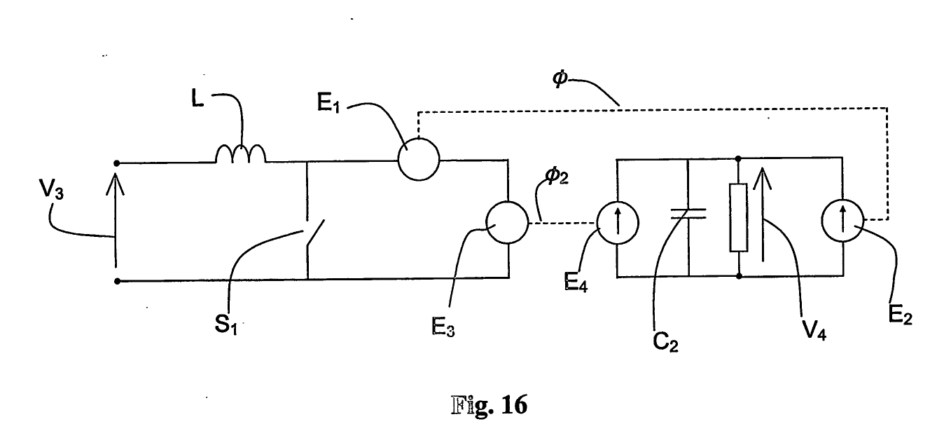

FIG. 16 shows a switch mode power supply as shown in FIG. 3, but having a galvanic isolation provided after voltage source E₁. The galvanic isolation is shown as a second voltage source E₃ on the primary side and a second current source E₄ on the secondary side, the second voltage source E₃ and the second current source E₄ exchanging energy via flow φ₂. A switch mode power supply may be provided with an ordinary transformer to constitute the galvanic isolation, but as such a transformer must transfer voltage of the mains frequency, such as 50 Hz, said transformer has a not inconsiderable size. Placing the galvanic isolation after the voltage source results in several advantages which are described below.

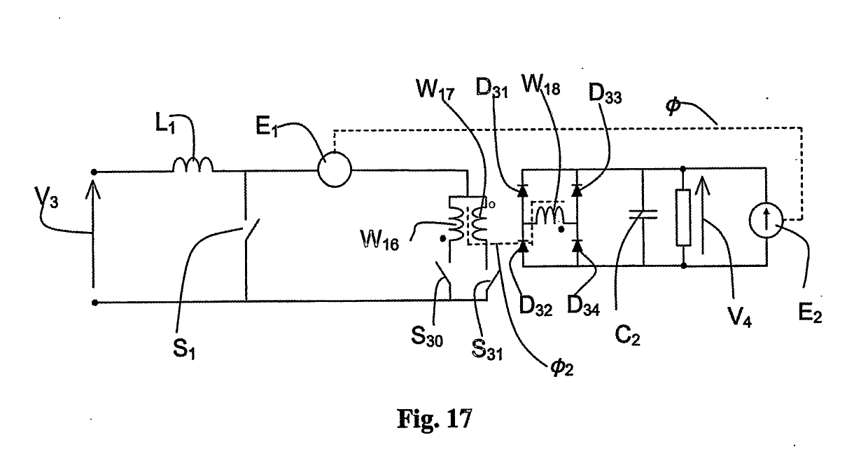

FIG. 17 shows an embodiment of a switch mode power supply according to the present invention with galvanic isolation. Two diodes D₃₁ and D₃₂ are connected in series on the secondary side, and the cathode of one of the diodes D₃₁ is connected to the positive pole of output V₄, whereas the anode of the second diode D₃₂ is connected to the negative pole of output V₄. A third and fourth diode D₃₃ and D₃₄ are connected in a similar fashion. A winding W₁₈ is connected between the anode of the first diode D₃₁ and the anode of the third diode D₃₃. On the primary side, a first and second winding W₁₆, W₁₇ are each connected in series to voltage supply E₁. Each winding W₁₆, W₁₇ is connected in series to a first and a second electronic breaker component S₃₀, S₃₁, the outputs of which being interconnected as well as connected to the negative pole of input V₃. The two windings W₁₆, W₁₇ exchange energy with winding W₁₈ by means of flow φ₂. Said two windings W₁₆ and W₁₇ have opposite dot notation.

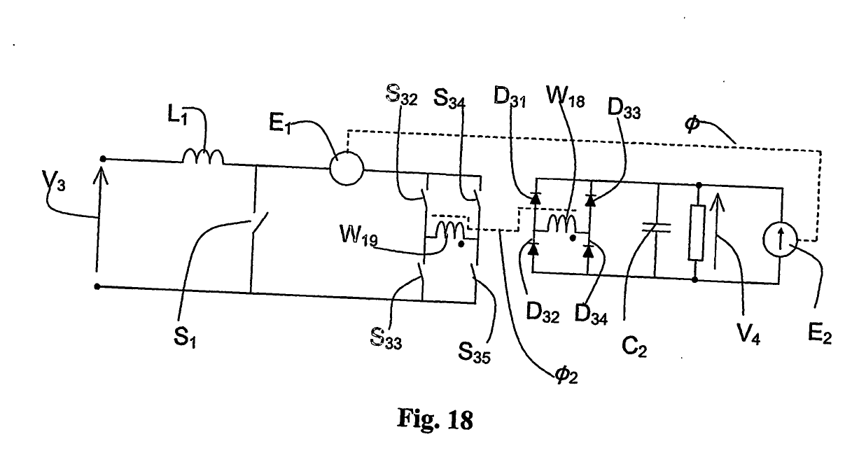

FIG. 18 shows an embodiment of a switch mode power supply with galvanic isolation, where the secondary side corresponds to the one shown in FIG. 17. On the primary side, a first, second, third and fourth breaker component S₃₂, S₃₃, S₃₄, S₃₅ are positioned in the form of an H bridge arrangement between voltage supply E₁ and the negative pole of input V₃. A winding W₁₉ exchanging energy with winding W₁₈ via flow φ₂ is placed as the horizontal leg of the H bridge.

In the two embodiments shown in FIGS. 17 and 18, the voltage transferred through the galvanic isolation is a DC voltage, and this is possible as described below, since the electronic breaker components S₃₀₋₃₅ act according to a push pull principle.

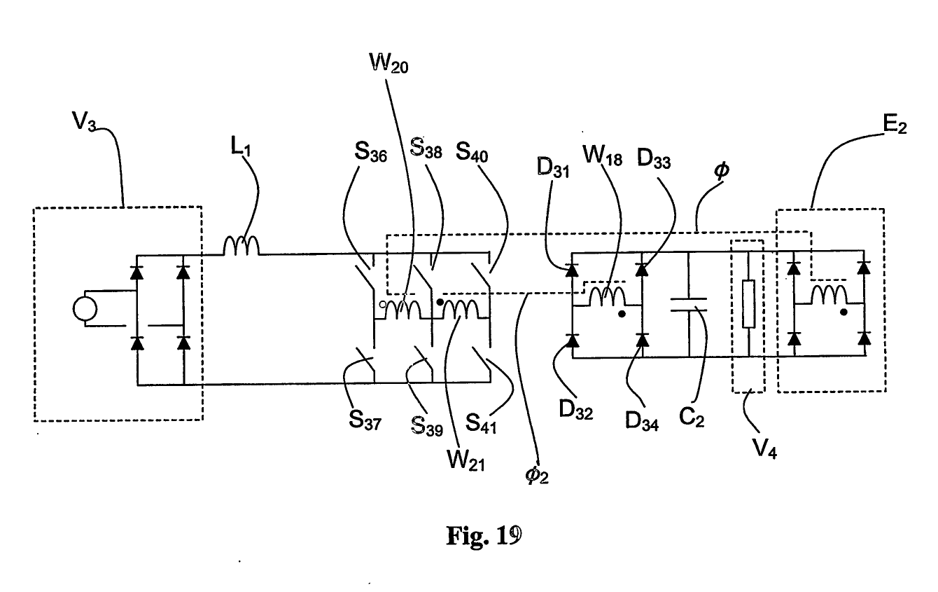

FIG. 19 shows an embodiment of a switch mode power supply with galvanic isolation, where voltage source E₁ and the second voltage source E₃ are in the form of a combined unit, where the secondary side corresponds to the one shown in FIGS. 17 and 18. A first, second, third, fourth, fifth and sixth electronic breaker component S₃₆₋₄₁ are arranged in a double H bridge arrangement between the inductor L₁ and the negative pole of input V₃. A first and second winding W₂₀, W₂₁ are placed as the two horizontal legs of the double H bridge. The first winding W₂₀ exchanges energy with current source E₂ via flow φ, and the second winding W₂₁ exchanges energy with the second current source E₄ via flow φ₂. Thus, the first winding W₂₀ acts as voltage source E₁ and the second winding W₂₁ acts as the second voltage source E₃. The two windings W₂₀, W₂₁ can be short-circuited, connected in series or in parallel and their polarity can be reversed, depending on how the electronic breaker components S₃₆₋₄₁ are switched on or off. This will be described in greater detail below.

It should be noted that when comparing FIG. 16 with FIG. 19 electronic breaker component S₁ has been removed from the circuit. The reason is that the function of the electronic breaker component S₁ in a boost converter circuit can be taken over by two or more of the electronic breaker component S₃₆₋₄₁ of the double H bridge, and the total number of components is thus a little less. This also allows the usage of so-called “six-pack” transistor module containing three totem poles. It may also be advantageous to retain electronic breaker component S₁. In this case a MOSFET may be used as electronic breaker component S₁ of the boost converter and IGBTs for the remaining electronic breaker components S₃₆₋₄₁. Thus ability of the MOSFET to turn on and off fast is exploited as well as the ability of the IGBTs to conduct current with little loss.

The present invention also relates to a method of controlling devices described above.

As mentioned above, one switch mode power supply according to the present invention is described based on a boost converter, but other converter types may be used in the present context. In the case of a boost converter, the proper operation of said converter requires that output voltage V₄ is higher than input voltage V₃. The method of controlling the power supply according to the present invention is described on the basis of the boost converter shown in FIG. 4. If output voltage V₄ is higher than input voltage V₃, the prerequisite for the proper operation of a boost converter, when there is no need for any inventive measures. These can cease by simultaneously switching on both electronic breaker components S₅ and S₆. Since the two windings W₁ and W₂ have opposite dot notation, the flux induced by each of the two windings cancel each other out, and in practice only a leakage flux is present. If output voltage V₄ is lower than input voltage V₃, a boost converter does normally not operate properly. The inductive coupling between voltage source E₁ and current source E₂ induces a voltage across winding W₁, when the electronic breaker component S₆ is switched off. Likewise, a voltage is induced across winding W₂, when electronic breaker component S₅ is switched on while electronic breaker component S₆ is simultaneously switched off. Because of the opposite dot notation of windings W₁ and W₂ the current through winding W₃ changes polarity sign, while diodes D₅, D₆, D₇ and D₈ ensure that the current of current source E₂ flows always in the same direction.

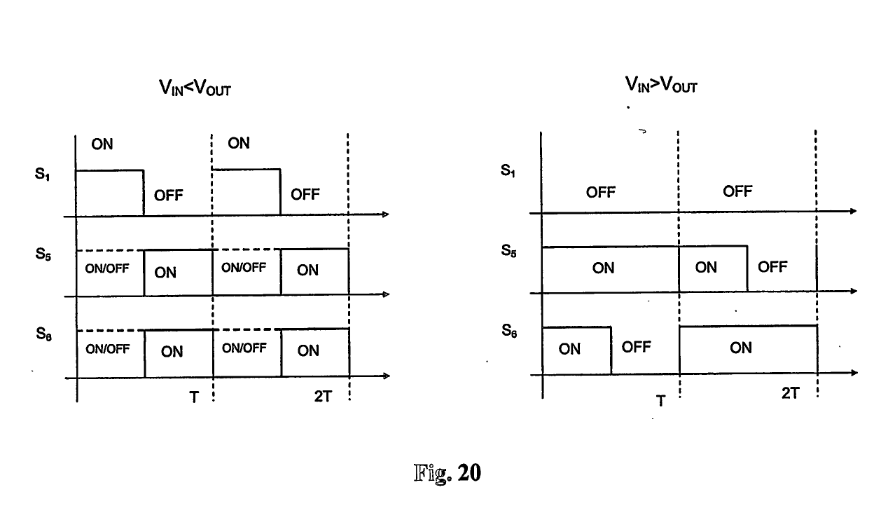

FIG. 20 illustrates schematically and based on FIG. 4 which electronic breaker components S₁, S₅ and S₆, respectively, must be switched on and off during a cycle of the PWM signal. Said components are shown for the two scenarios, when the input voltage is lower than the output voltage and when the input voltage is higher than the output voltage.

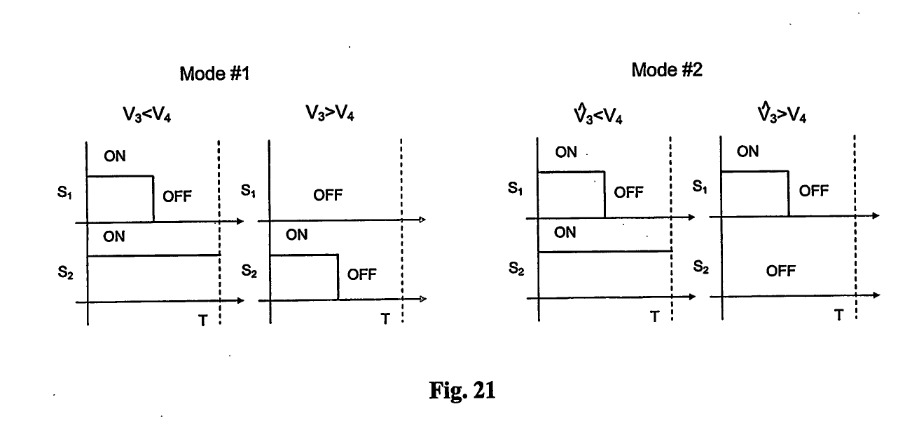

FIG. 21 illustrates two examples of which electronic breaker components of FIG. 14 are switched on and off during a cycle of the PWM signal. This is determined by the input voltage V₃ being smaller or larger than the output voltage. Mode # 2 differs from Mode # 1 by the maximum value V₃ and not the current value of input voltage V₃ determining, which electronic breaker components S₁ and S₁₉ are switched on and off.

The power supply of FIG. 10 and FIG. 11 differs from the above power supplies by the input voltage being a pure AC voltage and not a rectified AC voltage. The two voltage sub-sources E₃ and E₄ are alternately used during a half period each of the supply voltage, i.e. one is used when the voltage is positive and the other is used when the voltage is negative. Further it is only necessary to use means according to the present invention when the output voltage is lower than the input voltage. Therefore and when the mains voltage increases after having passed through zero, the input voltage is low and the boost circuit can operate properly and increase the voltage to the desired output voltage. As the voltage increases towards the maximum value of a sinusoidal voltage, it is possible that the input voltage at one moment is higher than the output voltage. Means according to the present invention can alter the apparent ratio between input voltage V₃ and output voltage V₄ and can thus contribute to maintaining the operation of the boost circuit. Voltage source E₃ becomes inactive again, when the input voltage decreases to a value below the value of the output voltage. Likewise, voltage sub-source E₄ is used for input voltage V₃ during the negative half-cycle. Thus, the input voltage V₃ does not require rectification and the flexibility of the boost converter is considerably increased.

The controlled voltage sources E₁ and current sources E₂, as illustrated in FIGS. 4 to 11, are functionally complementary to each other, their effect on the boost converter being the same, even though the number of components and their locations may vary. The scope of the present invention, however, is not limited to these functionally complementary couplings.

As described above, FIGS. 17 and 18 show a switch mode power supply with galvanic isolation. The galvanic isolation comprises electronic breaker components S₃₀₋₃₅, and these are controlled according to the push pull principle with an approximately 50/50 duty cycle. The push pull principle and galvanic isolation diodes D₃₁₋₃₄ allow a transfer of DC currents. Since the load current can vary with time, it may be appropriate to adjust the duty cycles of electronic breaker components S₃₀₋₃₅, thereby maintaining the average flow φ₂ at approximately zero and avoiding that the core materials used in the galvanic isolation become saturated and cause distortions.

FIG. 19 shows an embodiment where voltage source E₁ and current source E₂ are combined. Depending on the ratio of input voltage V₃ and output voltage V₄ there are two different states, A and B, for the current supply to assume. State A applies, when V₃<V₄, and state B, when V₃>V₄.

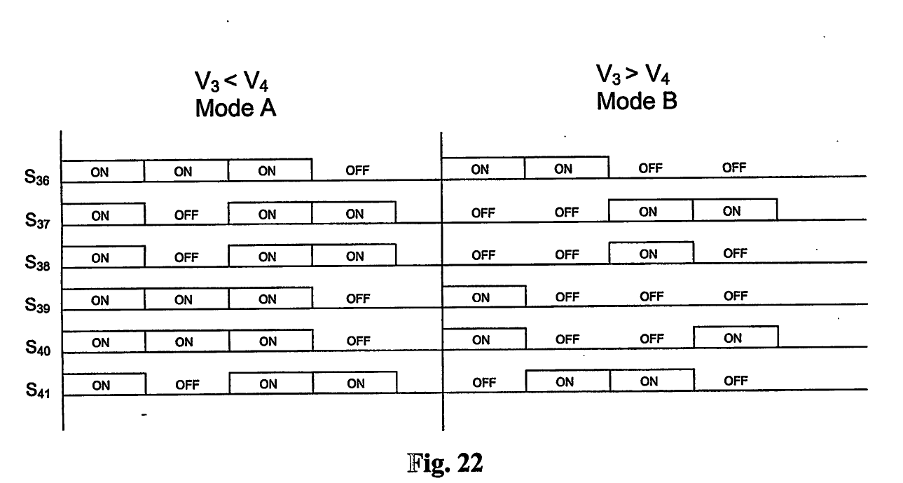

FIG. 22 shows, how electronic breaker components S₃₆₋₄₁ are turned on an off, depending on the assumed state. In state A, input voltage V₃<V₄, which is normal for a boost converter. Inductor L₁ is charged with energy by all electronic breaker components S₃₆₋₄₁ being turned on, thereby short-circuiting the two voltage sources E₁, E₃. When only galvanic isolation is required, the first, fourth and fifth electronic breaker component S₃₆, S₃₉, S₄₀ are turned on, and the electronic breaker component of the second, third and sixth electronic breaker component S₃₇, S₃₈, S₄₁ are turned off. Thus, the two voltage sources are connected in parallel and thereby act as two galvanic isolations connected in parallel. This is an advantage, since the thermal load on the power supply is reduced. As shown, the subsequent cycle works correspondingly, the turning on and off of the electronic breaker components, however, being reversed.

In state B, input voltage V₃>V₄, which makes it necessary to connect voltage source E₁ between input V₃ and output V₄ in order to obtain a ratio enabling the functioning of the boost converter as described above. Inductor L₁ is charged with energy by the first, fourth and fifth electronic breaker component S₃₆, S₃₉, S₄₀ being turned on, and the second, third and sixth electronic breaker component S₃₇, S₃₈, S₄₁ being turned off, thereby connecting voltage source E₁ and current source E₂ in parallel. Then, the first and sixth electronic breaker component S₃₆, S₄₁ are turned on, and the remaining ones turned off, thereby connecting to the two sources in series and transferring energy to capacitor C₂. The subsequent cycle is correspondingly, the turning on and off of the electronic breaker components, however, being reversed.

The voltage of the controlled voltage source E₁ depends partly on the control of the electronic breaker components of voltage source E₁ and partly on the ratio between the number of turns of the windings as well as output voltage V₄. Depending on which of the electronic breaker components are switched on, the induced voltage or the induced voltage with negative polarity is added to output voltage V₄, thus changing the apparent ratio between input voltage V₃ and output voltage V₄, thereby enabling the operation of the boost converter.

It should also be noted that the effect on the circuit can cease by switching on electronic breaker components S₅, S₆, S₇, S₈, S₉, S₁₀, S₁₁ and S₁₂, if the voltage of the controlled voltage source E₁ is not required to alter the apparent ratio between input voltage V₃ and output voltage V₄, i.e. when the ratio between input voltage V₃ and output voltage V₄ is sufficient to ensure the operation of the boost converter circuit and results in a satisfactory efficiency.

A circuit as described above can be altered without thereby deviating from the scope of the present invention. The polarity of the voltages and components can, for example, be reversed, which still results in a circuit of the same function. It is equally possible to find other, complementary forms for voltage source E₁ and current source E₂.

It should be noted that even though the circuit described above is described on the basis of a well-known boost converter circuit, voltage source E₁ and current source E₂ can also be used in connection with other converter types to alter the apparent ratio between input voltage and output voltage which is described briefly based on a buck converter.

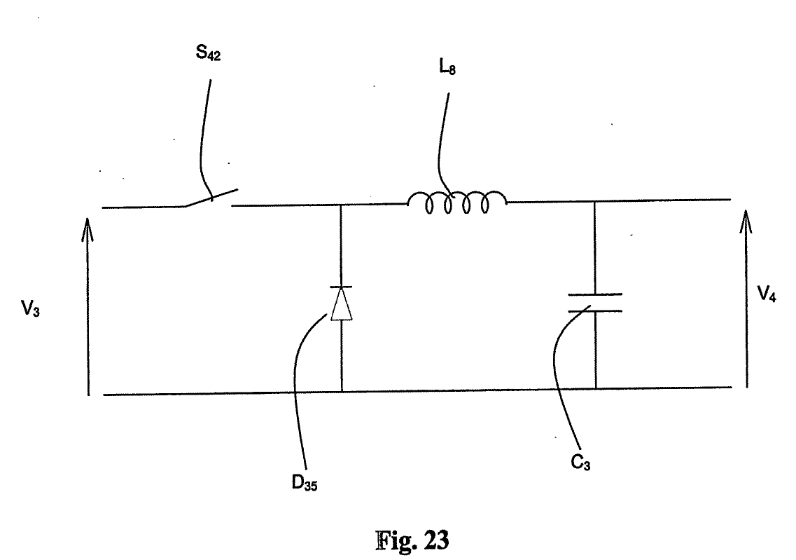

FIG. 23 shows a normal type buck converter comprising the same components as the boost converter shown in FIG. 2, but with a different mutual position. In contrast to the boost converter, the buck converter can scale down an input voltage. If for one reason or other output voltage V₄ is higher than input voltage V₃, the function of the converter will be interrupted and there will be no means to control the amount of output voltage V₄. If means are provided to alter the apparent ratio between input and output voltage V₃, V₄ in the same way as for the boost converter, the converter continues to function.

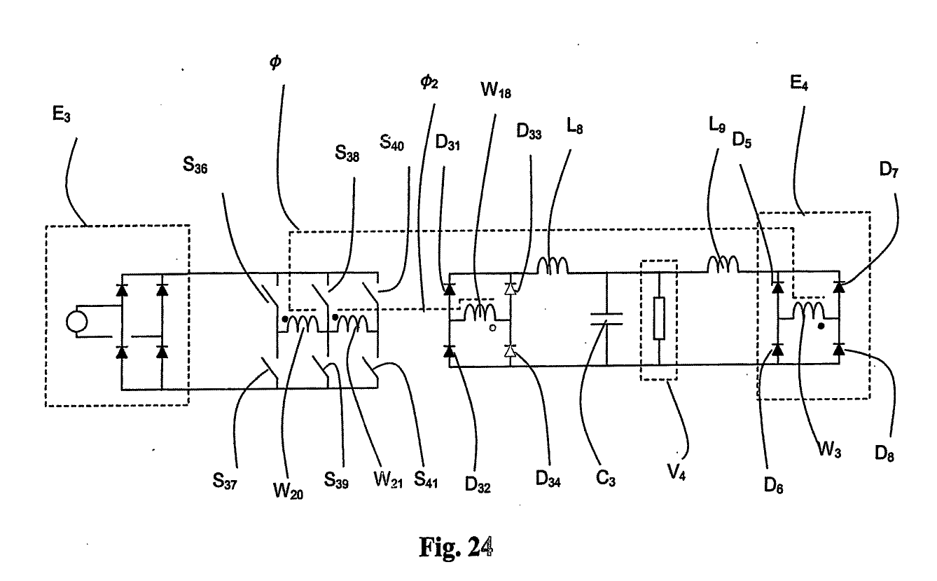

FIG. 24 shows a buck converter like the one shown in FIG. 23 modified by a circuit shown in FIG. 19. The function of diode D₂₅ is taken over by the connections in series D₃₁ and D₃₂, D₃₃ and D₃₄, D₅ and D₆ as well as D₇ and D₈. The modified buck converter acts in many ways as two buck converters connected in parallel, for which reason an additional inductor L₉ has been added. As mentioned in connection with the boost converter, the two windings W₂₀, W₂₁ act as two voltage sources, and these can be connected in parallel or in series by means of electronic breaker components S₃₆₋₄₁, short-circuited or disconnected as well as the mutual polarization compared to the input voltage can be determined.

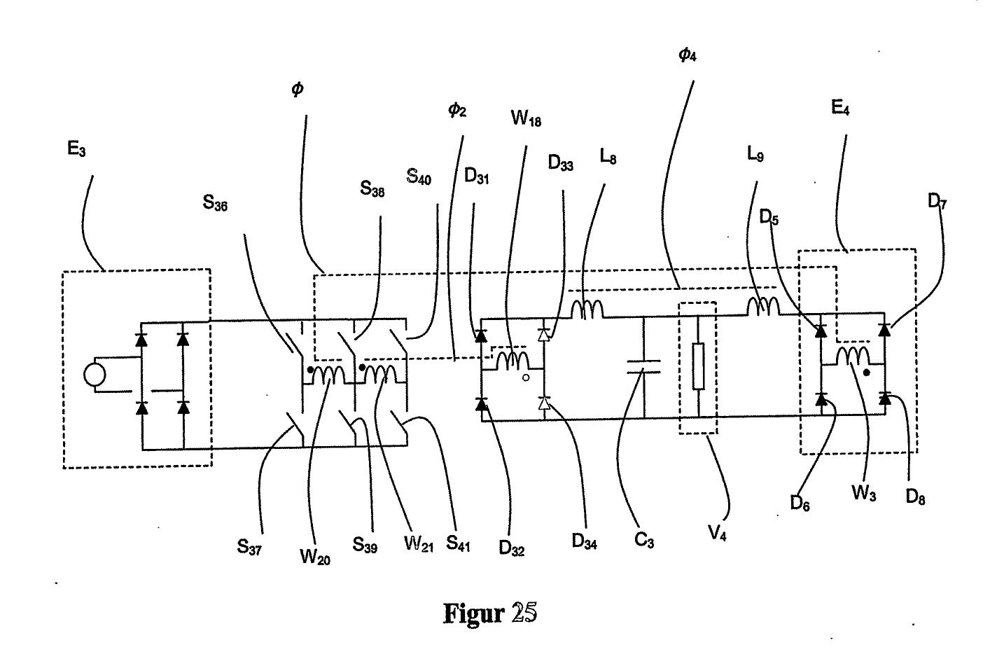

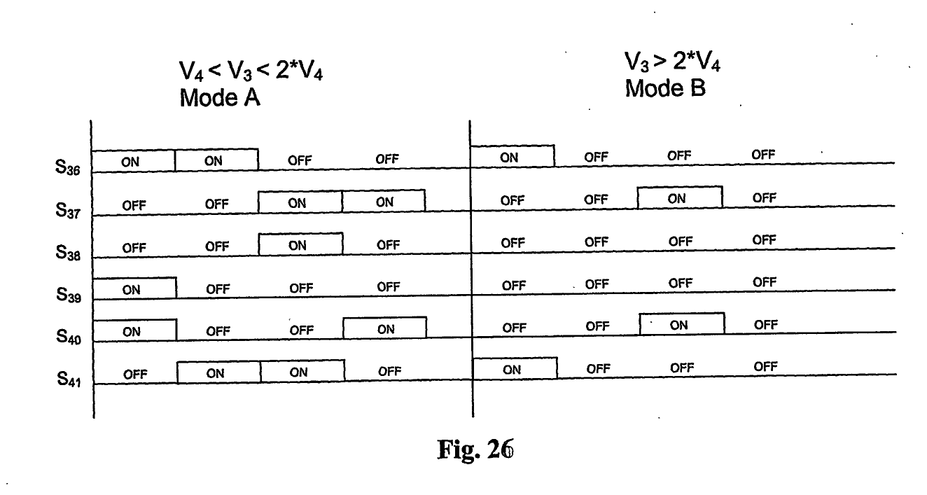

It is important for the function of the converter that a current of the same value flows through inductors L₈, L₉. During normal functioning of the converter differences are leveled out, however, this can result in an unnecessary current load of the two inductors L₈, L₉. This is solved in a simple fashion, as shown in FIG. 25, where there is a coupling φ₄ between the two inductors L₈, L₉.

In the same way as the boost converter a converter of this type has two states depending on the ratio between the input voltage and the output voltage. In a first state A V₄<V₃<2×V₄, and in a second state B V₃<2×V₄. This is shown in FIG. 25. In state A there is a first charge period and a second discharge period. In the first charge period electronic breaker components S₃₆, S₃₉ and S₄₀ are turned on and electronic breaker components S₃₇, S₃₈, S₄₁ are turned off. Subsequently, electronic breaker components S₃₆, S₄₁ are turned on during the discharge period, and electronic breaker components S₃₇, S₃₈, S₃₉, S₄₀ are turned off. In the following period—in order to reach an energy balance—electronic breaker components S₃₇, S₃₈, S₄₁ are turned on during the charge period while electronic breaker components S₃₆, S₃₉ and S₄₀ are turned off, and electronic breaker components S₃₇, S₄₀ are turned on during the discharge period while electronic breaker components S₃₆, S₃₈, S₃₉, S₄₁ are turned off. In state B, i.e. when input voltage V₃ is higher than twice the output voltage V₄, electronic breaker components S₃₆ and S₄₁ are turned on during the charge period, while the remaining ones are turned off, and all breaker components are turned off during the discharge period. Subsequently—in order to reach an energy balance electronic breaker components S₃₇ and S₄₀ are turned on during the charge period while the remaining ones are turned off, and all breaker components are turned off during the discharge period. In practice the converter acts as two buck converters connected in parallel in state B.

The invention has been described above on the basis of several embodiments, but the principle according to the invention of changing the apparent ratio between an input voltage and an output voltage can be used in many forms for converters, where this ratio is not necessarily always known. Neither should the principle be understood in a limiting fashion, since it can be used in connection with many different types of converters.

1. Switch mode power supply having an input (V₃), an output (V₄) and a circuit in between, characterized in that a voltage source (E₁) is provided in the intermediate circuit between the input (V₃) and the output (V₄) and that a current supply (E₂) is provided across the input (V₃), the voltage of the voltage source (E₁) being dependent on the voltage of the current source (E₂).

2. Switch mode power supply according to claim 1, characterized in that the voltage of the voltage source (E₁) either corresponds to the voltage of the current source (E₂) scaled with a fixed ratio or is a ratio varying with time.

3. Switch mode power supply according to claim 1, characterized in that the voltage source (E₁) comprises a winding (W₁) one side being connected in series to the input of an electronic breaker component (S₅) and a winding (W₂) one side being connected in series to the input of an another electronic breaker component (S₆), the outputs of said two electronic breaker components (S₅, S₆) being interconnected, and the other ends of said windings (W₁, W₂) being interconnected and said two windings being located on the same core (φ), and the voltage of said voltage source (E₁) being induced between the other ends of said two windings (W₁, W₂) and the outputs of said two electronic breaker components (S₅, S₆).

4. Switch mode power supply according to claim 1, characterized in that the voltage source (E₁) comprises a first electronic breaker component (S₇) an output being connected to the input of a second electronic breaker component (S₈), said voltage source (E₁) further comprising a third electronic breaker component (S₉) an output being connected to the input of a fourth electronic breaker component (S₁₀), the input of said first electronic breaker component (S₇) being connected to the input of said third electronic breaker component (S₉) and the output of said second electronic breaker component (S₈) being connected to the output of said fourth electronic breaker component (S₁₀), and a winding (W₄) being provided between said input of the second electronic breaker component (S₇) and the input of said third electronic breaker component (S₉), and the voltage of said voltage source (E₁) being induced between the input of said first electronic breaker component (S₇) and the output of said second electronic breaker component (S₈).

5. Switch mode power supply according to claim 1, characterized in that the voltage source (E₁) comprises a first diode (D₁₁) its cathode being connected to the input of a first electronic breaker component (S₁₁), the voltage source (E₁) further comprising a second diode its cathode being connected to the input of a second electronic breaker component (S₁₂), the outputs of said electronic breaker components (S₁₁, S₁₂) being interconnected, that a winding (W₇) is connected between the anodes of said diodes (D₁₁, D₁₂), that the voltage of the voltage source (E₁) is induced between the outputs of said electronic breaker components (S₁₁, S₁₂) and either the anode of said first diode (D₁₁) or the anode of said second diode (D₁₂), and the outputs of said electronic breaker components (S₁₁, S₁₂) being connected to the positive pole of the output (V₄), that the anode of said first diode (D₁₁) is connected to one side of a first inductor (L₂) and the input of an electronic breaker component (S₁₃), that the anode of said second diode (D₁₂) is connected to one side of a second inductor (L₃) and the input of an electronic breaker component (S₁₄), that the other sides of said two inductors (L₂, L₃) are interconnected and connected to the positive pole of the input (V₃), and that the other sides of said electronic breaker components (S₁₃, S₁₄) are interconnected and connected to the negative poles of the input (V₃) and the output (V₄).

6. Switch mode power supply according to claim 1, characterized in that the voltage source (E₁) comprises a first and a second voltage sub-source (E₃ and E₄), that the first voltage sub-source (E₃) comprises a first winding (W₈) one end being connected to one side of an electronic breaker component (S₁₅), and that the first voltage sub-source (E₃) further comprises a second winding (W₉) one end being connected to one side of a second electronic breaker component (S₁₆), that the other sides of said electronic breaker components (S₁₅ and S₁₆) are interconnected, that the other ends of said windings (W₈, W₉) are interconnected, that the windings (W₈, W₉) have opposite dot notation, that the second voltage sub-source comprises a first winding (W₁₀) one side being connected to one side of an electronic breaker component (S₁₇), that the second voltage sub-source (E₄) further comprises a second winding (W₁₁) one end being connected to one side of a second electronic breaker component (S₁₈), that the other sides of said electronic breaker components (S₁₇, S₁₈) are interconnected, that the other ends of said windings (W₁₀, W₁₁) are interconnected, that the windings (W₁₀, W₁₁) have opposite dot notation, that one side of said first voltage sub-source (E₃) is connected to the anode of a diode (D₁₃), that one side of said second voltage sub-source (E₄) is connected to the anode of a diode (D₁₄), that the cathodes of said diodes (D₁₃, D₁₄) are interconnected and connected to the positive pole of the output (V₄), that the other side of said first voltage sub-source (E₃) is connected to one side of an inductor (L₄) and one side of an electronic breaker component (S₁₃), that the other side of said second voltage sub-source (E₄) is connected to one side of an inductor (L₅) and one side of an electronic breaker component (S₁₄), and that the other sides of said electronic breaker components (S₁₃, S₁₄) are interconnected and connected to the negative pole of the output (V4).

7. Switch mode power supply according to claim 1, characterized in that the voltage source (E₁) comprises a first and a second voltage sub-source (E₃, E₄), that the first voltage sub-source (E₃) comprises a first electronic breaker component (S₁₉) one side being connected to one side of a second electronic breaker component (S₂₀), that the first voltage sub-source (E₃) comprises a third electronic breaker component (S₂₀) one side being connected to one side of a fourth electronic breaker component (S₂₂), that the other sides of said first and third electronic breaker component (S₁₉, S₂₁) are interconnected and connected to one side of an inductor (L₄) and one side of an electronic breaker component (S₁₃), that the other sides of the second and fourth electronic breaker component (S₂₀, S₂₂) are interconnected and connected to the anode of a diode (D₁₅), that a winding (W₁₂) is connected between the connection point between said first electronic breaker component (S₁₉) and said second electronic breaker component (S₂₀) and the connection point between said third electronic breaker component (S₂₁) and said fourth electronic breaker component (S₂₂), that the second voltage sub-source (E₄) comprises a first electronic breaker component (S₂₃) one side being connected to one side of an electronic breaker component (S₂₄), that the second voltage sub-source (E₄) further comprises an electronic breaker component (S₂₅) one side being connected to one side of an electronic breaker component (S₂₆), that the other sides of said first and third electronic breaker component (S₂₃, S₂₅) are interconnected and connected to one side of an inductor (L₅) and one side of a breaker component (S₁₄), that the second and fourth electronic breaker component (S₂₄, S₂₆) are interconnected and connected to the anode of a diode (D₁₆), that the cathodes of said diodes (D₁₅, D₁₆) are interconnected and connected to the positive pole of the output (V₄), and that the other sides of said electronic breaker components (S₁₃, S₁₄) are interconnected and connected to the negative pole of the output (V₄).

8. Switch mode power supply according to claim 6, characterized in that the inductors (L₄, L₅) are located on the same core.

9. Switch mode power supply according to claim 1, characterized in that the current source (E₂) comprises a first and a second diode (D₅, D₆) interconnected in series, the cathode of said first diode (D₅) being connected to the positive pole of the output (V₄) and the anode of said second diode (D₆) being connected to the negative pole of the output (V₄), said current source (E₂) further comprising a third and a fourth diode (D₇, D₈) interconnected in series and connected in parallel to said first and second diode (D₅, D₆), the cathode of said third diode (D₇) being connected to the cathode of said first diode (D₅) and the anode of said fourth diode (D₈) being connected to the anode of said second diode (D₆), and a winding (W₃) being provided between the anode of said first diode (D₅) and the anode of said third diode (D₇).

10. Switch mode power supply according to claim 1, characterized in that the current source (E₂) comprises a first diode (D₉) its anode being connected to one end of a first winding (W₅) and a second diode (D₁₀) its anode being connected to one end of a second winding (W₆), the cathodes of said two diodes (D₉, D₁₀) being interconnected and connected to the positive pole of the output (V₄), the other ends of said windings (W₅, W₆) being interconnected and connected to the negative pole of the output (V₄).

11. Switch mode power supply according to claim 1, characterized in that the inductors (L₁, L₂, L₃, L₄, L₅) of the switch mode power supply are located on the same core as the windings (W₃, W₄, W₅, W₆, W₇, W₈, W₉, W₁₀, W₁₁, W₁₂, W₁₃, W₁₄, W₁₅) of the controlled voltage source (E₁) and the current source (E₂).

12. Switch mode power supply according to claim 1, characterized in that the current source (E₂) is connected from the negative pole of the output (V₄) and to the connection point between the voltage source (E₁) and the anode of the diode (D₁).

13. Switch mode power supply according to claim 12, characterized in that the controlled voltage source (E₁) and the current source (E₂) comprise a first electronic breaker component (S₂₇) connected to one end of a first winding (W₁₄), that the controlled voltage source (E₁) and the current source (E₂) comprise a second electronic breaker component (S₂₈) connected to one end of a second winding (W₁₅), that the other ends of the electronic breaker components (S₂₇, S₂₈) are interconnected and connected to the connection point between the inductor (L₁) and the electronic breaker component (S₁), that the other ends of said first and second winding (W₁₄, W₁₅) are interconnected and connected to the anode of said diode (D₁), that the first and second winding (W₁₄, W₁₅) have opposite dot notation, that the cathode of a first diode (D₁₇) is connected to the connection point between said first electronic breaker component (S₂₇) and said first winding (W₁₄), that the cathode of a second diode (D₁₈) is connected to the connection point between said second electronic breaker component (S₂₈) and said second winding (W₁₅), that the anodes of the first and second diode (D₁₇, D₁₈) are interconnected and connected to the negative pole of the output (V₄).

14. Switch mode power supply according to claim 12, characterized in that one side of the inductor (L₁) is connected to the positive pole of the input (V₃), that the other side of said inductor (L₁) is connected to the input of a first electronic breaker component (S₁), the input of a second electronic breaker component (S₂₉) and one side of a first capacitor (C₃), respectively, that the output of said second electronic breaker component (S₂₉) is connected to the cathode of a first diode (D₂₀), the anode of a second diode (D₁) and one side of a second inductor (L₆), respectively, that the other side of said second inductor (L₆) is connected to the other side of said first capacitor (C₃) and the anode of a third anode (D₁₉), respectively, that the cathode of said third diode (D₁₉) is connected to the cathode of said second diode (D₁), one side of a second capacitor (C₂) and the positive pole of the output (V₄), respectively, and that the negative pole of the input (V₃) is connected to the output of a first electronic breaker component (S₁), the anode of said first diode (D₂₀), the other side of said second capacitor (C₂) and the negative pole of the output (V₄), respectively, the voltage source (E₁) and the current source (E₂) being comprised of said first capacitor (C₃), said second electronic breaker component (S₂₉), said first diode (D₂₀) and said second inductor (L₆).

15. Switch mode power supply according to claim 1, characterized in that one side of an inductor (L₇) is connected to the anode of a diode (D₃₀), that the other side of said inductor (L₇) is connected to the negative pole of the output (V₄), that the cathode of said diode (D₃₀) is connected to the positive pole of the output (V₄), that the inductor (L₇) is wound on the same core as the inductor (L₁), and that the inductor (L₇) has the same dot notation as the inductor (L₁).

16. Switch mode power supply according to claim 1, characterized in that the electronic breaker components, diodes and voltages have opposite polarities.

17. Switch mode power supply according to claim 1, having a galvanic isolation with a primary side and a secondary side, characterized in that the galvanic isolation is placed after the voltage source (E₁) and before the output (V₄) and comprising a second voltage source (E₃) on the primary side and a second current source (E₄) on the secondary side, said second voltage source (E₃) and said second current source (E₄) exchanging energy via the flow (φ₂).

18. Switch mode power supply according to claim 17, characterized in that the second current source (E₄) comprises a first diode (D₃₁), the anode of which being connected to the cathode of a second diode (D₃₂), and a third diode (D₃₃), the anode of which being connected to the cathode of a fourth diode (D₃₄), with the cathode of the first diode (D₃₁) and the cathode of the third diode (D₃₃) being interconnected and connected to the positive pole of the output (V₄), and with the anode of the second diode (D₃₂) and the anode of the fourth diode (D₃₄) being interconnected and connected to the negative pole of the output (V₄), and with a winding (W₁₈) being connected between the anode of the first diode (D₃₁) and the anode of the third diode (D₃₃).

19. Switch mode power supply according to claim 17, characterized in that the second voltage source (E₃) comprises a first winding (W₁₆), one end of which being connected to the input of a first electronic breaker component (S₃₀), a second winding (W₁₇), one end of which being connected to the input of a second electronic breaker component (S₃₁), that the other end of the first winding (W₁₆) is connected to the other end of the second winding (W₁₇) and to the voltage source (E₁), that the output of the first electronic breaker component (S₃₀) and the output of the second electronic breaker component (S₃₁) are interconnected and connected to the negative pole of the input (V₃), that the dot notation of the first winding (W₁₆) is opposite to the dot notation of the second winding (W₁₇), and that either the first winding (W₁₆) or the second winding (W₁₇) generate the flow (φ₂).

20. Switch mode power supply according to claim 17, characterized in that the output of a first electronic breaker component (S₃₂) is connected to the input of a second electronic breaker component (S₃₃), that the output of a third electronic breaker component (S₃₄) is connected to the input of a fourth electronic breaker component (S₃₅), that the input of the first electronic breaker component (S₃₂) is connected to the input of the third electronic breaker component (S₃₄) and to the voltage source (E₁), that the output of the second electronic breaker component (S₃₃) is connected to the output of the fourth electronic breaker component (S₃₅) and to the negative pole of the input (V₃), that a winding (W₁₉) is connected between the output of the first electronic breaker component (S₃₂) and the output of the third electronic breaker component (S₃₄), and that the winding (W₁₉) generates the flow (φ₂).

21. Switch mode power supply according to claim 1, having a galvanic isolation with a primary side and a secondary side, characterized in that the galvanic isolation comprises a second voltage source (E₃) on the primary side and a second current source (E₄) on the secondary side, the second voltage source (E₃) and the second current source (E₄) exchanging energy via the flow (φ₂), where the voltage source (E₁) and the second voltage source (E₃) are a combined unit, said combined unit being obtain by the output of a first electronic breaker component (S₃₆) being connected to the input of a second electronic breaker component (S₃₇), the output of a third electronic breaker component (S₃₈) being connected to the input of a fourth electronic breaker component (S₃₉), the output of a fifth electronic breaker component (S₄₀) being connected to the input of a sixth electronic breaker component (S₄₁), the input of the first electronic breaker component (S₃₆) being connected to the input of the third electronic breaker component (S₃₈), to the input of the fifth electronic breaker component (S₄₀) and to the positive pole of the input (V₃) via the inductor (L₁), the output of the second electronic breaker component (S₃₇) being connected to the output of the fourth electronic breaker component (S₃₉), to the output of the sixth electronic breaker component (S₄₁) and to the negative pole of the input (V₃), a first winding (W₂₀) being connected between the output of the first electronic breaker component (S₃₆) and the output of the third electronic breaker component (S₃₈), a second winding (W₂₁) being connected between the output of the third electronic breaker component (S₃₈) and the output of the fifth electronic breaker component (S₄₀), the first winding (W₂₀) exchanging energy via the flow (φ) and the second winding (W₂₁) exchanging energy via the flow (φ₂).

22. Method of controlling the switch mode power supply according to claim 1, characterized in that the electronic breaker components (S₅, S₆, S₇, S₈, S₉, S₁₀, S₁₁, S₁₂, S₁₃, S₁₄, S₁₅, S₁₆, S₁₇, S₁₈, S₁₉, S₂₀, S₂₁, S₂₂, S₂₃, S₂₄, S₂₅, S₂₆, S₂₇, S₂₈, S₂₉) of the voltage supply (E₂) are turned on, the voltage of the voltage source (E₁) thus being approximately zero, when the ratio between the input voltage (V₃) and the output voltage (V₄) is sufficient to ensure the operation of the switch mode type power supply, while the electronic breaker components (S₅, S₆, S₇, S₈, S₉, S₁₀, S₁₁, S₁₂, S₁₃, S₁₄, S₁₅, S₁₆, S₁₇, S₁₈, S₁₉, S₂₀, S₂₁, S₂₂, S₂₃, S₂₄, S₂₅, S₂₆, S₂₇, S₂₈, S₂₉) are switched on and off in such a way that the voltage across the voltage source (E₁), seen from the input side of the switch mode power supply, is added to or subtracted from the output voltage (V₄), when the ratio between the input voltage (V₃) and the output voltage (V₄) is insufficient or unsuitable to ensure the operation of the switch mode power supply so that the apparent ratio between the input voltage (V₃) and the output voltage (V₄) ensures the operation of the switch mode power supply.

23. Method of controlling a switch mode power supply with galvanic isolation according to claim 1, characterized in that the duty cycle of the electronic breaker components (S₃₀, S₃₁, S₃₂, S₃₃, S₃₄, S₃₅) of the galvanic isolation is predominantly 50/50.

24. Method according claim 23, characterized in that the duty cycle is adjusted to maintain a mean value for flow (φ₂) of approximately zero.

25. Method of controlling a switch mode power supply with galvanic isolation according to claim 21, characterized in that the method has a state A and a state B, and that state A corresponds to the input voltage (V₃) being lower than the output voltage (V₄) and state B corresponds to the input voltage (V₃) being higher than the output voltage (V₄),
that in state A energy is charged to the inductor (L₁) by turning on the electronic breaker components (S₃₆, S₃₇, S₃₈, S₃₉, S₄₀, S₄₁), thereby short-circuiting the two voltage sources (E₁, E₃),
that in state (A) energy is discharged from the inductor (L₁) by turning on the first, fourth and fifth electronic breaker component (S₃₆, S₃₉, S₄₀) and turning off the second, third and sixth electronic breaker component (S₃₇, S₃₈, S₄₁) or turning on the second, third and sixth electronic breaker component (S₃₇, S₃₈, S₄₁) and turning off the first, fourth and fifth electronic breaker component (S₃₆, S₃₉, S₄₀), thereby connecting the two voltage sources (E₁, E₃) in parallel and discharging the energy from the inductor (L₁) to the capacitor (C₂),
that in state (B) energy is charged to the inductor (L₁) by turning on the first, fourth and fifth electronic breaker component (S₃₆, S₃₉, S₄₀) and turning off the second, third and sixth electronic breaker component (S₃₇, S₃₈, S₄₁) or turning on the second, third and sixth electronic breaker component (S₃₇, S₃₈, S₄₁) and turning off the first, fourth and fifth electronic breaker component (S₃₆, S₃₉, S₄₀), thereby connecting the two voltage sources (E₁, E₃) in parallel, and
that in state (B) the first and sixth electronic breaker component (S₃₆, S₄₁) are turned on and the second, third, fourth and fifth electronic breaker component (S₃₇, S₃₈, S₃₉, S₄₀) are turned off or the second and fifth electronic breaker component (S₃₇, S₄₀) are turned on and the first, third, fourth and sixth electronic breaker component (S₃₆, S₃₈, S₃₉, S₄₁) are turned off, thereby connecting the two voltage sources (E₁, E₃) in series and discharging the energy from the inductor (L₁) to the capacitor (C₂).
